(19) United States
(12) Patent Application Publication
(10) Pub. No.: US 2001/0005464 A1
(43) Pub. Date: Jun. 28, 2001

(54) Automatic paper feed device

(75) Inventor: Takumi Funada, Niigata (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/746,996

(22) Filed: Dec. 21, 2000

(30) Foreign Application Priority Data
Dec. 22, 1999 (JP) 364134/1999

(51) Int. Cl. B41J 11/42

(52) U.S. Cl. 400/578; 400/582

(57) ABSTRACT

In whichever direction a paper feed motor rotates, a pick-up roller rotates in one direction by a one-way mechanism. Transmission of rotating power from the paper feed motor to the pick-up roller is connected or disengaged by a timing gear. The timing gear is initialized by a sensor before paper feeding. The transmission of rotating power from the paper feed motor to the one-way mechanism is connected or disengaged by movement of a slide gear. A carriage with a print head is scanned by a carriage motor to move the slide gear. When the paper feed motor is rotated in one direction, the pick-up roller is rotated in one direction to feed the paper, and the paper enters between a feed roller and an urging roller. When the feed roller and the urging roller rotate in a direction opposite to a paper feeding direction, the paper is returned to the direction opposite to the paper feeding direction and skewing is corrected. Subsequently, the paper is fed toward the carriage by the rotation of the feed roller and the urging roller in the paper feeding direction.

### BACKGROUND OF THE INVENTION

1. Field of the Invention

The present invention relates to an automatic paper feed device, and more particularly, relates to an automatic paper feed device for feeding sheet materials in a printer, a copying machine, or the like.

2. Description of the Related Art

A conventional automatic paper feed device will now be described in detail with reference to FIGS. 1 to 8. The automatic paper feed device is disclosed in Japanese Unexamined Patent Publication (JP-A) No. 236669 of 1998.

FIG. 1 is a schematic view illustrating a construction in the conventional art and shows a state prior to the feeding of paper. FIG. 2 is a view of the state in which paper is picked up by a pick-up roller in the conventional example. FIG. 3 is a view of the state in the conventional example in which, after the paper is picked up, an end of the paper is brought into contact with a feed roller to correct the skew. FIG. 4 is a view of the state in the conventional example in which, after the skew of the paper is corrected, the paper is conveyed. FIG. 5 is a view of the state in the conventional example when printing is performed on the paper. FIG. 6 is a detail view illustrating a structure of a mechanism section in the conventional example. FIG. 7A is a perspective view of a timing gear for performing a paper feeding operation at a proper timing in the conventional example. FIG. 7B is a view showing a state in which the timing gear and a pick-up roller gear are engaged with each other. In addition, FIG. 8 is a timing chart illustrating an example of the operation in the conventional example.

Referring to FIGS. 5 and 6, a conventional automatic paper feed device 6 comprises a paper loading member 5 for loading a stack of paper 4, a pick-up roller 3 for conveying the topmost sheet of the loaded paper 4, an urging spring 7 and a cam 27 for urging the paper to the pick-up roller 3 or counteracting the urging thereof via the paper loading member 5, and a timing gear 21 for performing operations to rotate the pick-up roller 3 and to urge the urging spring 7 or to counteract the urging thereof.

The timing gear 21 comprises a gear section 21a having a notch section for connecting or disengaging power by the rotation of a paper feed motor 29 in a paper feeding direction 100 using a feed roller gear 30, a sun gear 22, and a planetary gear 23, as shown in FIGS. 6, 7A, and 7B. The timing gear 21 also comprises a gear section 21b for transmitting the rotation in a direction 101 opposite to the paper feeding direction (refer to FIG. 3) via an idle gear 25 continuously, a gear section 21c for transmitting the power for rotating a cam 27 for sliding or rotating the paper loading member 5, via a cam gear 26, and a gear section 21d having a notch section, for controlling the rotation of the pick-up roller 3 via a pick-up roller gear 28. The gear section 21d includes two notches, that is, a notch section 311 for disengaging the power to the pick-up roller 3 just before conveying a sheet of the paper 4, and a notch section 312 for disengaging the power to the pick-up roller 3 after bringing the sheet of the paper 4 into contact with the feed roller 1 and correcting the skew. The pick-up roller 3 and the pick-up roller gear 28 are fixed to the same shaft. The cam 27 is fixed to the cam gear 26 and presses down the paper loading member 5. The paper loading member 5 is linearly slid or is rotated around the fulcrum as the center.

Next, a paper intake operation will be described with reference to the views of the states as shown in FIGS. 1 to 5, mechanism detail views in FIGS. 6, 7A, and 7B, and the timing chart in FIG. 8.

Referring to FIGS. 1 and 6, when the feed roller 1 is continuously rotated in the paper feeding direction 100 by more than a specified amount by the paper feed motor 29 in the state prior to the feeding of a sheet of the paper 4, the planetary gear 23 is revolved from a position 23b to a position 23a, and the power is disengaged at a notch section of the gear section 21a of the timing gear 21, which becomes the home position. In this instance, as shown in FIGS. 7A and 7B, since the notch section 311 of the gear section 21d of the timing gear 21 faces the pick-up roller gear 28, the pick-up roller 3 is in a non-rotating state. The point in time of this state is shown as a state 301 at a starting point of time in FIG. 8. That is, the pick-up roller 3 and the paper 4 are stationary. In addition, since the paper loading member 5 is pressed down against the urging spring 7 by the cam 27, a sheet of the paper 4 is not urged by the pick-up roller 3 so as to be in a released state. Moreover, both of the feed roller 1 and the paper feed motor 29 are stopped.

Next, referring to FIGS. 2 and 6, the feed roller 1 is rotated in the direction 101 opposite to the paper feeding direction by the paper feed motor 29. The planetary gear 23 is revolved from the position 23a to the position 23b, and transmits the power to the gear section 21a of the timing gear 21 via the idle gear 25. In whichever direction the sun gear 22 is rotated, the power is transmitted to the gear section 21a of the timing gear 21 via the planetary gear 23 at the position 23a or the planetary gear 23 at the position 23b, and the idle gear 25, and consequently, the timing gear 21 is rotated in the same direction. In this manner, the cam 27 performs the operation from canceling of the urging to urging with respect to the paper loading member 5. The operations are shown as a state 302 in FIG. 8. That is, the pick-up roller 3 and a sheet of the paper 4 are stationary following the state 301. In addition, both the feed roller 1 and the paper feed motor 29 start to be rotated in the reverse direction from the stopped state. Moreover, the paper loading member 5 starts to urge a sheet of the paper 4 to the pick-up roller 3 by the force of the cam 27 and the urging spring 7. In this instance, as shown in FIGS. 7A and 7B, since the notch section 311 of the gear section 21d of the timing gear 21 faces the pick-up roller gear 28, the pick-up roller 3 is still in the non-rotating state.

Next, referring to FIGS. 3 and 6, when the feed roller 1 continues to be rotated in the direction 101 opposite to the paper feeding direction by the paper feed motor 29, the pick-up roller 3 starts to be rotated in the paper feeding direction, and the topmost sheet of the paper 4 is picked up by the pick-up roller 3. An end of a sheet of the paper 4 so picked up is brought into contact with the feed roller 1 that is rotated in the direction 101 opposite to the paper feeding direction, a specified amount thereof is deflected, and thereby the skew of the paper 4 is corrected. During the operation, the paper loading member 5 still maintains the urging state by the cam 27. The operation is shown as a state 303 in FIG. 8. That is, the pick-up roller 3 is rotated and the sheet of the paper 4 is moved in a forward feeding direction after being picked-up. The paper loading member 5, the feed roller 1, and the paper feed motor 29 are in the last process of the state 302.

Then, the feed roller 1 continues to be rotated in the direction 101 opposite to the paper feeding direction by the paper feed motor 29 to perform the operations from the urging to the cancellation of the urging thereof via the paper loading member 5. In this instance, since the notch section 312 of the gear section 21d of the timing gear 21 faces the pick-up roller gear 28, the pick-up roller 3 is in a stopped state. This is shown as a state 304 in FIG. 8. That is, the pick-up roller 3 and the sheet of the paper 4 are stopped, and the paper loading member 5, the feed roller 1, and the paper feed motor 29 maintain the state 303.

Here, as shown in FIG. 4, when the feed roller 1 is rotated in the paper feeding direction 100 by the paper feed motor 29, the timing gear 21 shown in FIGS. 6, 7A, and 7B transmits the power to the pick-up roller 3 via the pick-up roller gear 28. When the feed roller 1 is rotated in the paper feeding direction 100, the pick-up roller 3 is rotated in the paper feeding direction 100 by the planetary gear 23 revolved to the position 23a to convey the sheet of the paper 4 from the upstream toward the feed roller 1, thereby enabling the sheet of the paper 4 to be nipped by an urging roller 2 and feeding the sheet of the paper 4 to a specified heading position. When the paper feeding to the heading position is completed, the timing gear 21 arrives at the home position by the notch section of the gear section 21a. This is shown as a state 305 in FIG. 8. Subsequently, as shown in FIG. 5, printing is executed by a print head mounted on a carriage 11 according to a printing command. This is shown after a state 306 in FIG. 8.

By using the timing gear 21 and the cam 27 corresponding to the urging spring 7 as described above, only the feed roller 1 is given a reverse rotation in the direction indicated by an arrow 101 by an intake command after a forward rotation in the direction indicated by an arrow 100 has been given thereto, and as a result, the sheet of the paper 4 can be discharged after correcting the skew of the sheet of the paper 4 conveyed by the pick-up roller 3.

The first problem in the above-described conventional automatic paper feed device is that there is disruption of line feed accuracy and an increase in a load on the paper feed motor. The reason for this is that since the paper is always urged by the pick-up roller, a frictional load of the pick-up roller is applied to the paper even during printing. The second problem is that because of control by switching the operation of only the paper feed motor, supply of the paper is slow.

### SUMMARY OF THE INVENTION

Accordingly, it is an object of the present invention to provide an automatic paper feed device in which a sheet of paper is urged by a pick-up roller only when necessary in order to avoid disruption of line feed accuracy and to avoid an increase in load on a paper feed motor.

It is another object of the present invention to provide an automatic paper feed device in which skewing of the paper to be fed is corrected.

It is another object of the present invention to provide an automatic paper feed device in which paper feeding is rapid.

According to the present invention, there is provided an automatic paper feed device, comprising: a roller section including a feed roller, an urging roller for urging said feed roller and conveying a sheet of paper by a frictional force, a pick-up roller for conveying the topmost sheet of paper which is loaded; a power transmitting section including a paper feed motor, a gear train for transmitting rotating power from the paper feed motor to the feed roller, a transmitting means for transmitting only the rotating power in one direction to the pick-up roller and the conveying means for conveying the topmost sheet of the paper so loaded, in whichever direction the paper feed motor is rotated, a rotation control gear for controlling the rotation and the stopping of the pick-up roller, and a sensor for initializing the rotation control gear; and a carriage section including a carriage having a print head mounted thereon for moving a slide gear for connecting and disengaging the rotating power from the gear train to the transmitting means, and a carriage motor for scanning the carriage.

Also, according to the present invention, there is provided an automatic paper feed device, comprising: a paper loading member for loading paper; a pick-up roller for conveying the topmost sheet of the paper which is loaded; an urging spring and a cam for urging the paper to the pick-up roller or canceling the urging thereof via the paper loading member; a timing gear for performing operations to rotate the pick-up roller and to urge the urging spring and to cancel the urging thereof via the cam; and a sensor for initializing the timing gear.

### BRIEF DESCRIPTION OF THE DRAWINGS

FIG. 1 is a side view of a first process in a conventional automatic paper feed device;

FIG. 2 is a side view of a second process in the conventional automatic paper feed device;

FIG. 3 is a side view of a third process in the conventional automatic paper feed device;

FIG. 4 is a side view of a fourth process in the conventional automatic paper feed device;

FIG. 5 is a side view of a fifth process in the conventional automatic paper feed device;

FIG. 6 is a perspective view showing essential parts of the conventional automatic paper feed device;

FIG. 7A is a perspective view of a timing gear in the conventional automatic paper feed device;

FIG. 7B is an enlarged front view of a state in which the timing gear and a pick-up roller gear are engaged with each other in the conventional automatic paper feed device;

FIG. 8 is a timing chart in the conventional automatic paper feed device;

FIG. 9 is a perspective view showing essential parts of an automatic paper feed device according to the embodiment of the present invention;

FIG. 10A is a perspective view of a timing gear in the automatic paper feed device according to an embodiment of the present invention;

FIG. 10B is a front view showing a state in which the timing gear and a pick-up roller gear are not engaged with each other in the automatic paper feed device according to the embodiment of the present invention;

FIG. 10C is a front view showing a state in which the timing gear and the pick-up roller gear start to be engaged with each other in the automatic paper feed device according to the embodiment of the present invention;

FIG. 11 is a timing chart of the automatic paper feed device according to the embodiment of the present invention; and

FIG. 12 is a perspective view of a one-way mechanism section in the automatic paper feed device according to the embodiment of the present invention.

### DESCRIPTION OF THE PREFERRED EMBODIMENTS

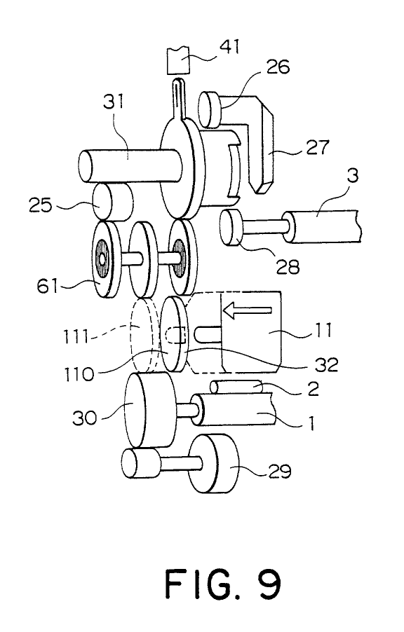

An embodiment of the present invention will now be described in detail with reference to FIGS. 9 to 12.

An automatic paper feed device shown in FIG. 9 comprises a paper loading member 5 for loading a stack of paper 4 (referring to FIG. 1 concerning the reference symbols 4, 5, 6, and 7), a pick-up roller 3 for conveying the topmost sheet of the loaded paper 4, an urging spring 7 and a cam 27 for urging the paper 4 to the pick-up roller 3 or canceling the urging thereof via the paper loading member 5, a timing gear 31 for performing both operations to rotate the pick-up roller 3 and to urge the urging spring 7 or cancel the urging thereof, and a sensor 41 for initializing the timing gear 31. The sensor 41 is a photosensor or a proximity sensor.

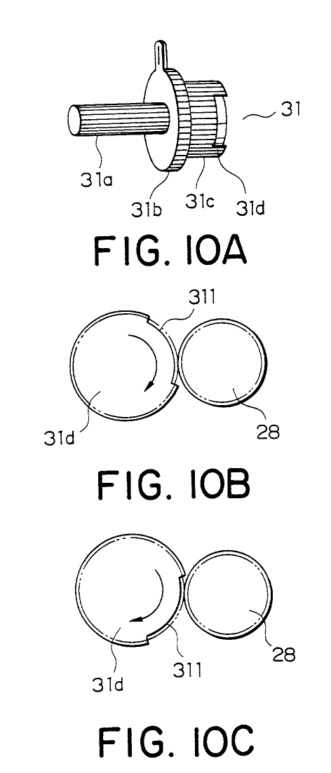

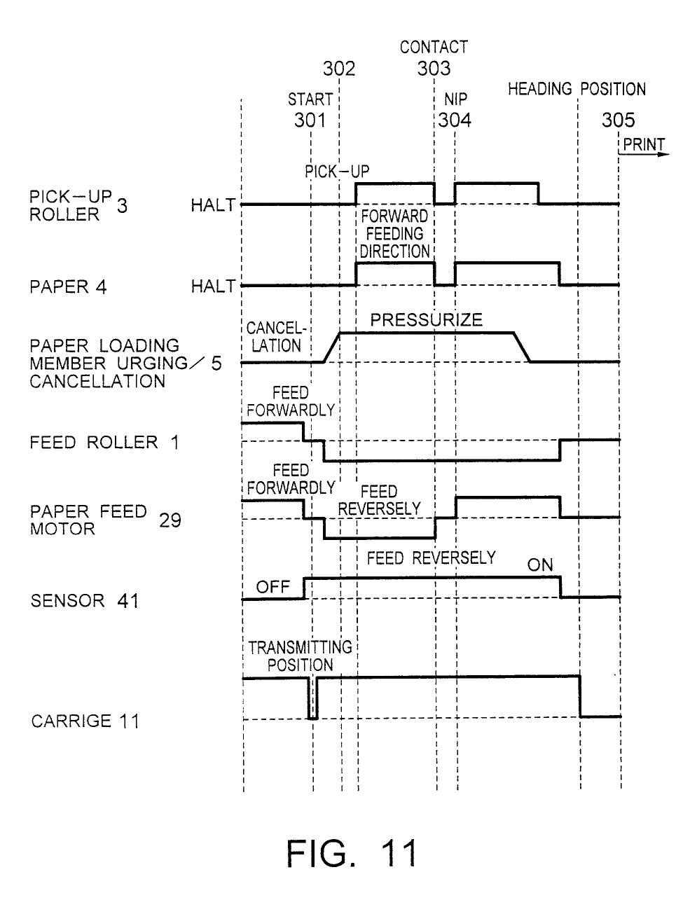

FIG. 10A is a perspective view showing details of the timing gear shown in FIG. 9, and FIGS. 10B and 10C are front views thereof.

The timing gear 31 is rotated in one direction by the rotation of a paper feed motor 29 via a feed roller gear 30, a slide gear 32 for connecting and disengaging the rotating power of the paper feed motor 29 to the automatic paper feed device 6 depending on the position of a carriage 11, and a one-way mechanism section 61 for continuously converting the rotating power of the paper feed motor 29 in two directions to rotation in one direction. The timing gear 31 comprises receiving sections 31a and 31b for receiving the rotating power in one direction, a notch section 31d for controlling the timing of the rotation of the pick-up roller 3, and a gear section 31c for transmitting the power for rotating a cam 27 for rotating or sliding the paper loading section 5, via the cam gear 26.

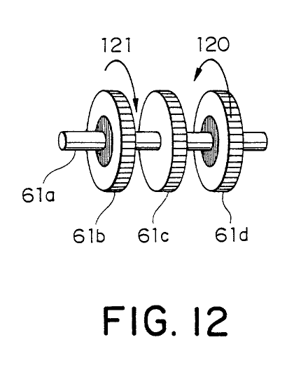

The carriage 11 can be moved in a direction indicated by the arrow in FIG. 9 by a carriage motor (not shown) for scanning the carriage 11, synchronized with the paper feed motor 29. In this instance, the carriage 11 presses and moves the slide gear 32 from a position 110 (position shown by a solid line) to a position 111 (position shown in a broken line). Although the slide gear 32 is not engaged with a shaft gear 61c (shown in FIG. 12) of the one-way mechanism section 61 at the position 110, the slide gear 32 is engaged with the shaft gear 61c at the position 111.

The pick-up roller 3 and a pick-up roller gear 28 are fixed on the same shaft. The cam 27 is fixed to a cam gear 26 to press down the paper loading member 5.

FIG. 12 is a perspective view showing details of the one-way mechanism section 61 in FIG. 9.

The one-way mechanism section 61 comprises a shaft 61a, the shaft gear 61c fastened to the shaft 61a, a one-way clutch gear B denoted by 61d having a one-way clutch therein so as to be engaged with the shaft 61a and to transmit the rotating power of the shaft 61a when rotated in a direction 120, and a one-way clutch gear A denoted by 61b having a one-way clutch therein for transmitting the rotating power of the shaft 61a when rotated in a direction 121.

In whichever direction the slide gear 32 is rotated, the power is transmitted to the timing gear 31 via the one-way clutch gear B denoted by 61d and the receiving section 31b, or the one-way clutch gear A denoted by 61b, an idle gear 25, and the receiving section 31a, and as a result, the timing gear 31 is rotated in the same direction.

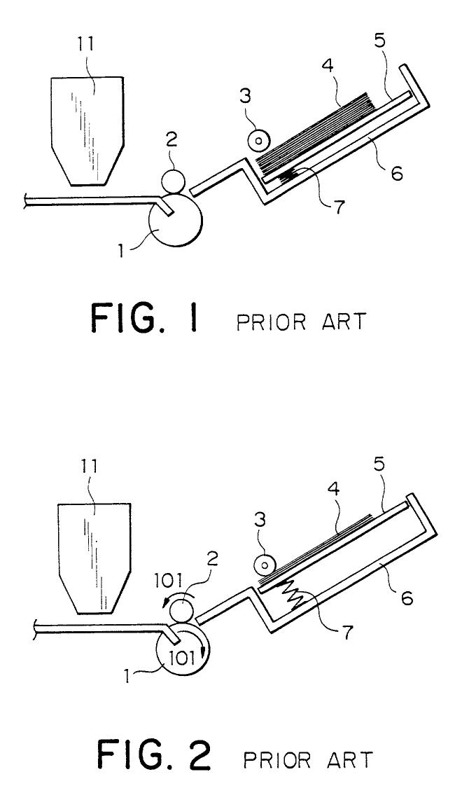

FIG. 11 is a timing chart showing the operation of the present invention. The operation will now be described with reference to FIGS. 1, 2, 3, 4, and 5 as well. In a state before feeding a sheet of the paper 4, the slide gear 32 is moved to the position 111 at which the power of the paper feed motor 29 is transmitted to the automatic paper feed device 6 to rotate the paper feed motor 29 (either in a paper feeding direction or in the opposite direction is possible), and to initialize the timing gear 31 by the sensor 41. This position becomes a home position of the automatic paper feed device 6.

In this instance, since a notch section 311 of the gear section 31d of the timing gear 31 faces the pick-up roller gear 28, the pick-up roller 3 is in a non-rotating state. The time of this state is a start time 301. That is, the pick-up roller 3 and the sheet of the paper 4 are stopped. Since the paper loading member 5 is pressed down against the urging spring 7 by the cam 27, the sheet of the paper 4 is in a released state without being urged by the pick-up roller 3. In addition, both the feed roller 1 and the paper feed motor 29 are stopped.

Subsequently, the slide gear 32 is moved to the position 111 at which the power of the paper feed motor 29 is transmitted to the automatic paper feed device 6 to rotate the paper feed motor 29 in the direction opposite to the paper feeding direction, the feed roller 1 is rotated in the direction 101 opposite to the paper feeding direction, and the operations from canceling the urging via the paper loading member 5 to the urging are performed by the cam 27. The paper loading member 5 starts to urge the sheet of the paper 4 to the pick-up roller 3 by the force of the cam 27 and the urging spring 7. In this instance, since the notch section 311 of the gear section 31d of the timing gear 31 faces the pick-up roller gear 28, the pick-up roller 3 is in the non-rotating state. This is shown as a state 302 in FIG. 11.

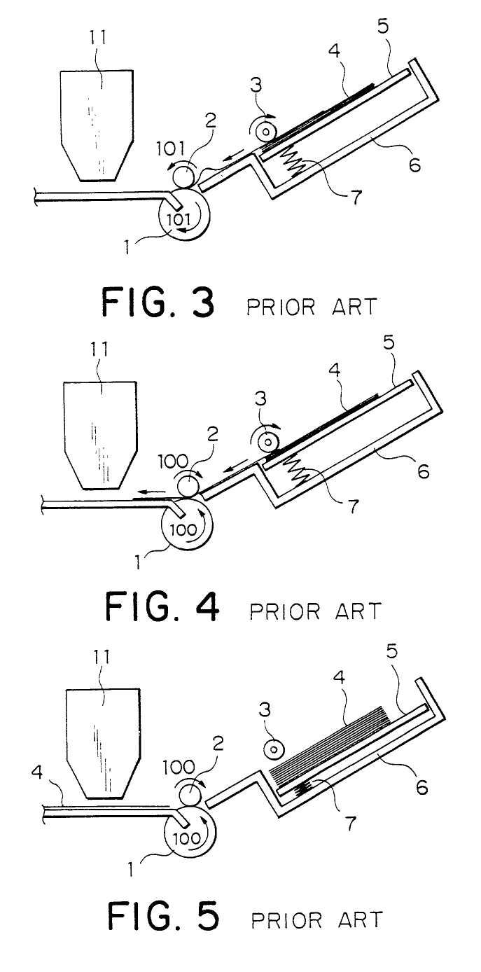

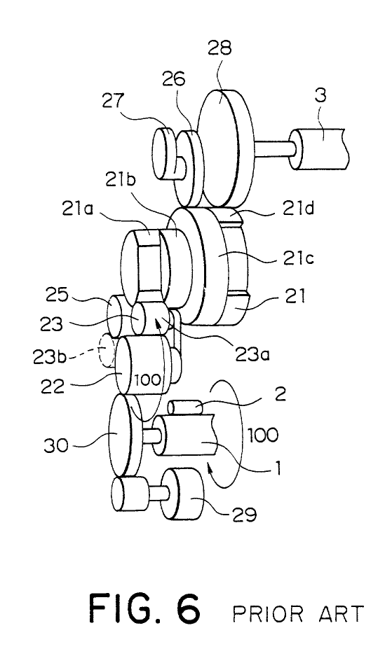

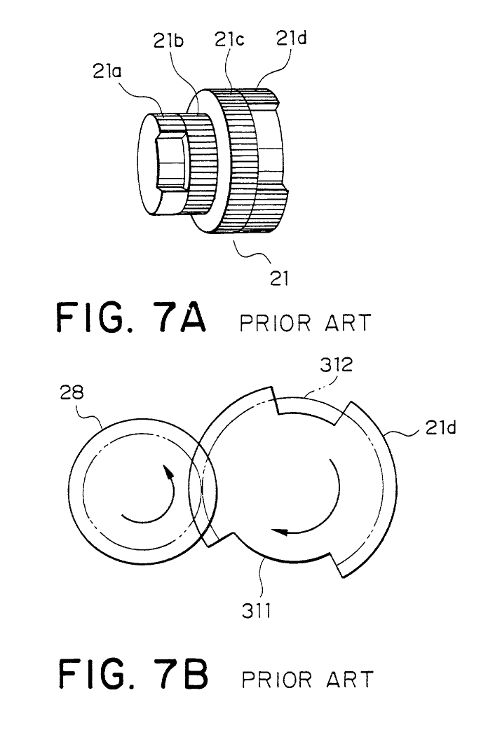

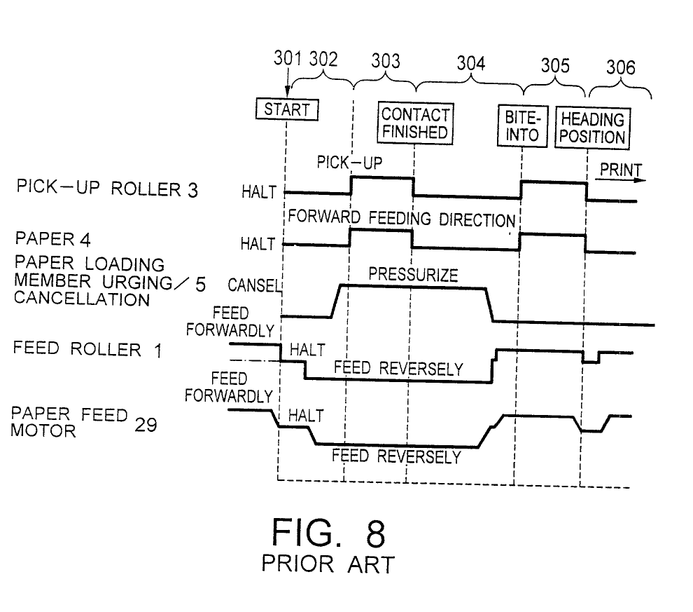

Next, when the feed roller 1 is rotated in the direction 101 opposite to the paper feeding direction by the paper feed motor 29, the pick-up roller 3 starts to be rotated in the paper feeding direction, and the topmost sheet of the paper 4 is picked up by the pick-up roller 3. The end of the sheet of the paper 4 so picked up is brought into contact with a contact of the feed roller 1 and the urging roller 2, which are rotated in the direction 101 opposite to the paper feeding direction, a specified amount of the paper is deflected, and thereby the skewing of the end of the paper is corrected. During this operation, the paper loading member 5 still maintains the urging state by the cam 27. The operation is shown as a state 303 in FIG. 3. That is, the pick-up roller 3 is rotated and the sheet of the paper 4 is moved in the forward feeding direction after being picked up, and the paper loading member 5, the feed roller 1, and the paper feed motor 29 are in the last process of the state 302.

Next, the feed roller 1 is rotated in the paper feeding direction 100 by the paper feed motor 29 to feed the sheet of the paper 4 from the feed roller 1 toward a print head mounted on the carriage 11. This is shown as a state 304 in FIG. 11. Furthermore, the paper feed motor 29 is rotated in the paper feeding direction 100 until the sensor 41 detects the feeding of the paper. During this operation, the operations from the urging to the cancellation of the urging via the paper loading member 5 are executed.

Subsequently, the slide gear 32 escapes to the position 110 at which the power of the paper feed motor 29 is not transmitted to the automatic paper feed device, and the paper feeding is completed. In this instance, since the timing gear 31 engaged with the pick-up roller gear 28 is rotated once, and the notch section 311 of the gear section 31d faces the pick-up roller gear 28, the pick-up roller 3 becomes stationary. This is shown as a state 305 in FIG. 11. After that, printing is executed by the print head mounted on the carriage 11 in accordance with a printing command. This is shown after a state 305 in FIG. 11.

The automatic paper feed device according to the present invention has advantages such that by using the timing gear 31 and the cam 27 facing the urging spring 7, after rotating the feed roller 1 in the forward direction shown by the arrow 100 by a discharge command, the reverse rotation in the direction shown by the arrow 101 is provided to the feed roller 1 and the urging roller 2 by an intake command, so that the sheet of the paper 4 can be discharged after correcting the skewing of the sheet of the paper 4 conveyed by the pick-up roller 3, and consequently, the paper feeding operation can be efficiently performed by combining the operations of a carriage scanning motor and the paper feed motor 29, thereby reducing the feeding time.

What is claimed is:

1. An automatic paper feed device, comprising:
a roller section including a feed roller, an urging roller for urging said feed roller and conveying a sheet of paper by a frictional force, a pick-up roller for conveying the topmost sheet of paper which is loaded;
a power transmitting section including a paper feed motor, a gear train for transmitting rotating power from said paper feed motor to said feed roller, a transmitting means for transmitting only the rotating power in one direction to said pick-up roller and said conveying means for conveying the topmost sheet of the paper so loaded, in whichever direction said paper feed motor is rotated, a rotation control gear for controlling the rotation and the stopping of said pick-up roller, and a sensor for initializing said rotation control gear; and
a carriage section including a carriage having a print head mounted thereon for moving a slide gear for connecting and disengaging the rotating power from said gear train to said transmitting means, and a carriage motor for scanning said carriage.

2. An automatic paper feed device as claimed in claim 1, wherein said sensor is a photosensor.

3. An automatic paper feed device as claimed in claim 1, wherein said sensor is a proximity sensor.

4. An automatic paper feed device, comprising:
a paper loading member for loading paper;
a pick-up roller for conveying the topmost sheet of the paper which is loaded;
an urging spring and a cam for urging said paper to said pick-up roller or canceling the urging thereof via said paper loading member;
a timing gear for performing operations to rotate said pick-up roller and to urge said urging spring and to cancel the urging thereof via said cam; and
a sensor for initializing said timing gear.

5. An automatic paper feed device as claimed in claim 4, wherein:
said timing gear is rotated in one direction via a feed roller gear for transmitting rotating power by a feed motor, a slide gear for connecting or disengaging the rotating power from said paper feed motor to the automatic paper feed device depending on the position of a carriage on which a print head is mounted, and a one-way mechanism section for continuously converting the rotating power in two directions from said paper feed motor to the rotation in one direction, and comprises:
a receiving section for the rotating power in one direction;
a notch section for controlling the timing of the rotation of said pick-up roller; and
a gear section for transmitting the power for rotating a cam for sliding or rotating said paper loading member via a cam gear.

6. An automatic paper feed device as claimed in claim 5, wherein said one-way mechanism section comprises:
a shaft;
a shaft gear affixed to said shaft;
a first one-way clutch gear having a one-way clutch therein so as to be engaged with said shaft when rotated in one direction and to transmit the rotating power of said shaft; and
a second one-way clutch gear having therein a one-way clutch for transmitting the rotating power of said shaft when rotated in the reverse direction.
